(19) United States
(12) Patent Application Publication
(10) Pub. No.: US 2026/0254805 A1
(43) Pub. Date: Aug. 27, 2026

(54) INTEGRATED CERTIFICATE MANAGEMENT

(71) Applicant: Palo Alto Networks, Inc., Santa Clara, CA (US)

(72) Inventors: Anurag Reddy Ekkati, Lathrop, CA (US); Ramesh Nampelly, Livermore, CA (US); PradeepKumar Vijaya Kumar, Dublin, CA (US); Puneet Gupta, Bangalore (IN)

(21) Appl. No.: 19/065,963

(22) Filed: Feb. 27, 2025

(51) Int. Cl. H04L 9/40

(52) U.S. Cl. CPC H04L 63/0823; H04L 63/108; H04L 63/20

(57) ABSTRACT

Integrated certificate management is disclosed. A configuration that declaratively defines a certificate lifecycle is received. A certificate is obtained in accordance with the configuration. A periodic determination is made as to whether the certificate is deployed in a manner consistent with the configuration. In response to the determining, a remediation is performed.

### BACKGROUND OF THE INVENTION

Certificates, such as Secure Sockets Layer (SSL) and Transport Layer Security (TLS) certificates are widely used to secure communications. Unfortunately, managing the lifecycle of such certificates is challenging-often time consuming and error prone. As one example, suppose a given website has a given certificate. If that certificate expires (without being renewed/replaced in a timely manner), communications with that website may be blocked (e.g., by a client browser policy) or allowed to continue but in an unsecured manner. Other problems with certificate lifecycles can also arise, and are generally currently handled in a highly manual, uncoordinated way. Therefore, improvements in certificate management would be desirable.

### BRIEF DESCRIPTION OF THE DRAWINGS

Various embodiments of the invention are disclosed in the following detailed description and the accompanying drawings.

FIG. 1 is an example of an environment in which integrated certificate management is provided.

FIG. 2 illustrates an embodiment of a certificate management platform.

FIGS. 3-7 illustrate examples of portions of various certificate configurations.

FIG. 8 illustrates various phases of certificate issuance and/or certificate update workflows.

FIG. 9 illustrates an example of a periodic reconciliation workflow.

FIG. 10 illustrates an example of a process for providing integrated certificate management.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. Introduction

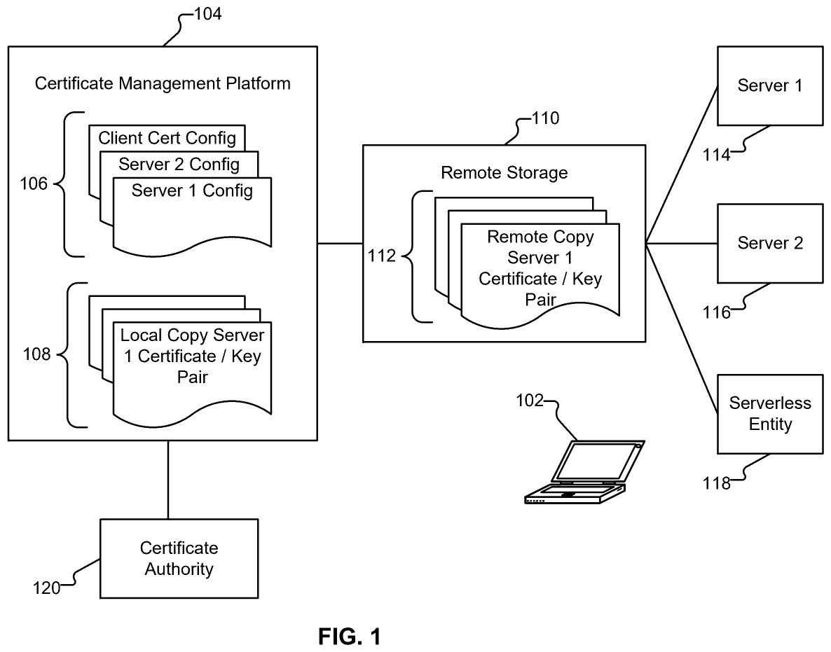

FIG. 1 is an example of an environment in which integrated certificate management is provided. In the example shown, various users (e.g., using device 102) interact with various applications provided by various infrastructure (e.g., server 114 running in a Kubernetes cluster, server 116 running in a virtual machine, and serverless entity 118). The infrastructure and applications variously make use of certificates, such as Secure Sockets Layer (SSL) and Transport Layer Security (TLS) certificates to secure communications. One of the more challenging and critical aspects of using such certificates is managing the lifecycle of those certificates-tasks such as creating, installing, renewing, and as applicable, revoking them. Frequent problems in managing certificate lifecycles include situations where certificates expire without being renewed, stale or other incorrect certificates are copied into production environments, certificate revocations aren't followed, persistence to remote storages, monitoring, executing custom workflows before or after certificate issuance/renewal, etc. The situation is exacerbated by the heterogenous nature of most modern environments (e.g., with infrastructure provided by different hardware/cloud service vendors, supporting different operating systems, and applications authored using a variety of different programing platforms/languages/etc.). Mitigating these issues can be extremely time consuming and error prone.

Embodiments of the environment shown in FIG. 1 provide various functionality that improves certificate lifecycle implementation and management. In the example shown, certificate management platform 104 uses configurations 106 (e.g., declaratively defined in YAML or using another appropriate definition scheme such as JSON) for each of the certificates 108 that certificate management platform 104 manages. Since each certificate has its own configuration, it can have its own custom set of enforceable requirements. The configuration contains metadata for the certificate as well as any optional features/corresponding parameters that should be used with those features as part of the lifecycle. Example elements of a configuration include information such as which applications (e.g., executing on server 114 or server 116) will make use of the certificate, how frequently it should be renewed, whether/which remote storage (or load balancer) the certificate should be synchronized with, which alerting channel to notify (PagerDuty, Slack, etc.) for errors or to initiate custom triggers, etc. This approach helps selectively enable/disable features specific to a given certificate, while providing details such as certificate metadata and authentication information in a uniform manner. The systematic integration of certificate lifecycle management with other modules supports a variety of powerful workflows that allow for customization, monitoring, validation, reconciliation, and alerting, providing for enhanced efficiency and accuracy.

Examples of various functionality provided by embodiments of the environment shown in FIG. 1 include the following (discussed in more detail below). Extensibility supports customizations around certificate lifecycle elements, providing the ability to trigger pre certificate issue/renewal workflows (proceeding only on success), as well as post certificate issue/renewal workflows (including monitoring status and alerting as necessary). Renewals can be scheduled strategically (e.g., during otherwise scheduled downtime or appropriate service windows, such as on particular days of the week at particular times, and with a flexible window of, e.g., 1-3 days before expiration to attempt renewal). Smart remote persistence with drift reconciliation of managed certificates (e.g., as 112) to one or more external secret stores 110 (such as GCP SecretsManager, AWS SecretsManager, and Hashicorp Vault) as well as certificate managers (such as AWS CertificateManagers and GCP CertificateManagers) for cloud load balancing provides for certificate management support for serverless executables and automatically scaling virtual machines. Adaptive approval services with smart remote persistence provides for issuance of client certificates on an approval basis with adaptive approval workflow (e.g., where, if an approval is withdrawn, the certificate will be revoked and removed from any applicable secret stores). Just in time (time bound) validity with smart remote persistence supports the automatic revocation/removal of client certificates after an approved time period is exhausted (e.g., in the event the time is not extended). Certificates not only need to be validated against expiration dates, but also proactively checked to see if they are part of a certificate authority (e.g., certificate authority 120's) certificate revocation list (or via OCSP requests). With a declarative definition of managed certificates, embodiments of platform 104 are able to build an inventory of runtime mappings of applications to certificates. Proactive run time validations and automatic remediation can be used, e.g., during the time of compromise and bulk revocations (and with the help of run time inventory) to secure applications, including by automatically renewing certificates as needed, e.g., by interacting with certificate authority 120. A variety of certificate authorities can be used by certificate management platform 104, including private corporate certificate authority solutions (e.g., EJBCA) as well as commercial certificate authorities (e.g., Let's Encrypt or GoDaddy). For example, a given configuration can specify that particular certificates be issued using an internal certificate authority (e.g., for intra-service communication), while other certificates be issued through commercial certificate authorities, e.g., for public-facing servers.

### II. Example Architecture

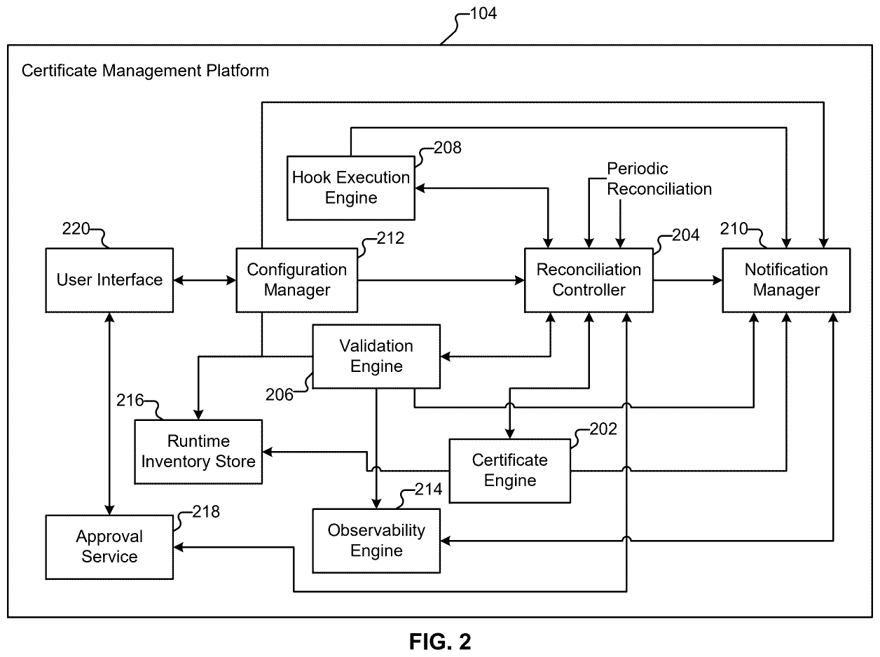

FIG. 2 illustrates an embodiment of a certificate management platform, such as certificate management platform 104. Certificate management platform 104 includes various components which interact with one another. While some examples of communications connections between components are illustrated, other connections may also be used (and/or are omitted to aid in readability). Certificate management platform 104 can be implemented across a scalable infrastructure comprising multiple servers, solid state drives or other storage and/or other applicable high-performance hardware. Certificate management platform 104 can comprise several distributed components, including components provided by one or more third parties. For example, portions or all of certificate management platform 104 can be implemented using the Amazon Elastic Kubernetes Service (EKS) and/or Elastic Compute Cloud (EC2) and/or Amazon Simple Storage Service (S3). Whenever certificate management platform 104 is referred to as performing a task, such as storing data or processing data, it is to be understood that a sub-component or multiple sub-components of certificate management platform 104 (whether individually or in cooperation with third party components) may cooperate to perform that task. In an example implementation, all of the components are implemented in Python. A kopf framework for Kubernetes is used.

Certificate engine 202 listens to reconciliation controller 204 for new certificate configurations and updates to existing certificate configurations (e.g., edits or deletions) and takes actions accordingly. Examples of actions taken by certificate engine 202 include new certificate issuance, certificate renewal, and certificate revocation. Certificate engine 202 communicates with validation engine 206 for input validations and also listens to incoming requests from validation engine 206 and hook execution engine 208 to trigger certificate generation or revocation workflows. Certificate engine 202 sends out appropriate notifications/alerts to notification manager 210.

Reconciliation controller 204 is the main executor of certificate management platform 104 and communicates with all other components, driving workflows described in certificate configurations 106 to achieve the intended result. Reconciliation controller 204 gets triggered periodically (e.g., every 30 minutes) to make sure the certificates are valid by triggering validation engine 206. If something is out of sync from a defined configuration, then the appropriate component(s) are triggered to remedy the situation (e.g., resync, fix, regenerate, notify). As one example, suppose a certificate 112 stored by certificate management platform 104 in remote storage 110 is manipulated (e.g., edited or overwritten) and is now different from a corresponding local reference copy 108. Reconciliation controller 204 notices the drift and triggers a resync (e.g., copying the encrypted local reference copy of certificate and private key back to the remote storage). Reconciliation controller 204 is also responsible for triggering revocation and removal of client certificates in the event of just-in-time access scenarios, as well as determining whether it is time to renew soon-to-expire certificates (e.g., in accordance with the expiration date and any renewal requirements specified in the certificate's associated configuration, e.g., as to timing, pre/post hooks, etc.).

Validation engine 206 communicates with (or listens to, as applicable) reconciliation controller 204 for new certificate configuration creation or updates to existing certificate configurations such as edits or deletions and performs input validation as applicable. Validation engine 206 also periodically validates managed certificate expiration, certificate and key pair matching, and drift detection (e.g., between a local reference copy and a remotely stored copy) when certificates are persisted to remote storage (e.g., storage 110). Validation engine 206 can validate whether a certificate serial number presented by a server endpoint is the same as one managed (and expected) by the platform. Validation engine 206 also can periodically validate whether the serial numbers of certificates managed by certificate management platform 104 are part of a certificate authority certificate revocation list.

Hook execution engine 208 listens to reconciliation controller 204 requests to execute pre hook jobs for certificate generation. Examples of such jobs include scripts, as well as webhook-based external jobs (e.g., ArgoCD, Gitlab, Jenkins, etc.). In response, hook execution engine 208 communicates the status of pre hook jobs with reconciliation controller 204 to proceed with certificate generation/renewal (assuming the job was successful). Hook execution engine 208 also listens to reconciliation controller 204 requests to execute post hook jobs after the issue/renewal of a certificate (e.g., to restart an application and load the new certificate into memory).

Notification manager 210 listens for notifications coming from all other components. The notification manager then channels a given notification to the appropriate communication method(s) (e.g., PagerDuty, Slack, email).

Configuration manager 212 keeps a record of all certificate configurations 106 and communicates with reconciliation controller 204 periodically which drives various certificate lifecycle management workflows across other components. Configuration manager 212 triggers events such as certificate configuration creation, certificate configuration update, and certificate configuration deletion with reconciliation controller 204.

Observability engine 214 listens to inputs coming in from validation engine 206 and generates Prometheus metrics. Observability engine 214 further listens to inputs coming in from other components to generate Prometheus error metrics. Observability engine 214 sends notifications to notification manager 210 in the event of errors generating metrics.

Runtime inventory store 216 stores certificate metadata and associated application mappings provided in the corresponding configuration as communicated by configuration manager 212, certificate engine 202, and validation engine 206. In an example implementation, runtime inventory store 216 is a time series database (e.g., Prometheus). It can also be any other appropriate type such as a relational, document, or object database (e.g., Mongo or MySQL). It provides a runtime inventory at any given point of time. In an example implementation, configurations (e.g., configurations) 112 include information such as which server(s)/other endpoints will be using which certificate(s) managed by certificate management platform 104. The information can be used as part of proactive monitoring, in which certificate management platform 104 periodically contacts a given endpoint and checks/validates the certificate (e.g., via a serial number in the server certificate) with the certificate that certificate management platform 104 expects (based on local copy 108). If a mismatch is found between the certificate the live system (endpoint server) is presenting and the expected certificate (local copy 108), remediation can be taken (e.g., refreshing the certificate at the endpoint, sending a notification, etc.). Further, if it is determined that a particular certificate serial number has been revoked, runtime inventory store 216 can be used to promptly determine which affected server(s) (using the certificate) need remediating.

Approval service 218 (e.g., in connection with a user interface 220) allows administrators or other appropriate entities to approve (or, as applicable, automatically approve) elements of the certificate management lifecycle. As an example, approval service 218 can be involved in workflows where approval (e.g., from an administrator) is required in order to generate client certificates, and where, if approval is withdrawn (or if an approval time window expires without the administrator renewing/extending it), the certificates are automatically revoked.

### III. Example Configurations

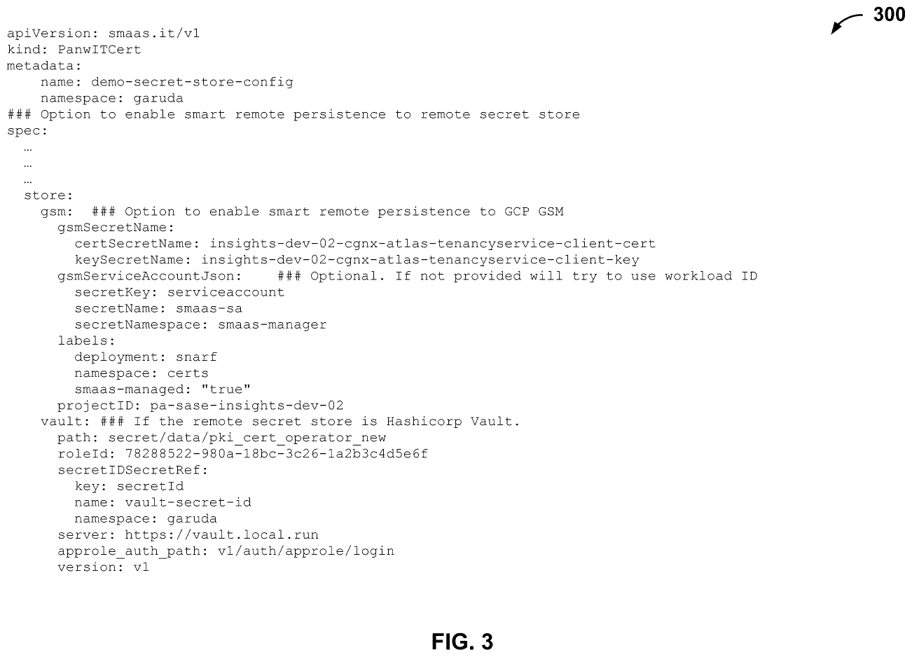

FIGS. 3-7 illustrate examples of portions of various certificate configurations. The configurations are declaratively defined in YAML, though other appropriate definition schemes can also be used. Configurations have common portions (e.g., each configuration indicating version number and other typical metadata such as is needed to generate a CSR such as common name for the certificate, DNS names, renewal timelines, country/state/location/organization information, etc.) as well as optional portions, which can be included/excluded based on various implementation needs. The configurations are stored as configurations 106 on certificate management platform 104 and can be provided/edited using a user interface, such as user interface 220 and can also be provided/edited using an applicable API provided by certificate management platform 104. The configurations allow administrators (or other appropriate parties) to specify, in fine detail, how certificates used by various applications should be stored/managed. And, adherence to those details can be monitored, and remedied, as applicable.

As an example, suppose an application running on server 114 has a certificate that needs to be rotated every three months. The application is a mission critical one, and has recurring but specific maintenance windows (e.g., every third Thursday between 3 am and 4 am). Further, suppose that in order to update the certificate in the application, a particular script needs to be executed (e.g., performing various tasks such as stopping the application or hot-patching the application, backing up information associated with the application, ultimately restarting the application, etc.). Certificate configuration options, such as scheduling particular constraints on renewals (e.g., only renewing on particular Thursdays at particular times; and/or executing pre/post-hook instructions such as running a certificate rotation script at a particular time) can be defined/applied to particular certificates/applications. Very fine grained rules can be specified, for example, so that the certificate is renewed at least three days in advance (e.g., on a Monday), but is not pushed to the live system until the scheduled maintenance window.

Using techniques described herein, applications can be made aware that a certificate upon which they rely has been renewed, and instructed to pull the updated certificate from the appropriate location at the appropriate time. As previously mentioned, additional constraints can exist and lead to complexity/fragility which is mitigated using techniques described herein.

As an example, a particular certificate used by a particular application may be stored (for use by the application) in a particular remote storage and/or need to be loaded into a particular load balancer. The configuration for the certificate can address these requirements as well. And, as described herein, consistency checks can be performed to ensure that the remotely stored certificate information is current/matches the reference version, and to make sure that, e.g., the certificate has not been revoked, and as applicable, that any just-in-time or other authorizations are met.

In some cases, revocation may be unintended, e.g., an administrator attempting to revoke a set of certificates may instead revoke the wrong set of certificates (including ones that should not have been revoked). In an environment without the services of certificate management platform 104, it might go un-noticed for some time that a valid certificate was unintentionally revoked—e.g., until someone happens to notice that an application has stopped working. Using the functionality of certificate management platform 104, revocations of any managed certificates can be identified quickly, and remediated.

As another example, serverless functions (e.g., provided by serverless entity 118) cannot manage their own certificates, and so another entity needs to manage such certificates (e.g., client certificates) on behalf of the serverless entity. Certificate management platform 104 is able to provide certificate support by ensuring certificates used by the serverless entity are up to date, not revoked, etc., and stored in the correct location (i.e., usable by the serverless entity). And, if someone changes or deletes the certificate at the location (inadvertently or maliciously), certificate management platform 104 is able to detect the problem and remediate it (e.g., by resynchronizing the reference copy of the certificate and performing any additional tasks with respect to the application, such as retriggering the serveless function after remediation, restarting the application at a particular time, etc.).

As yet another example, suppose an administrator would like to provide just-in-time access to a particular service (or other resource such as a device or API). The service can make use of client certificates to authenticate to the server providing the service. To support time-based limitations on access to the service, the configuration can specify that a client certificate be generated and stored (e.g., in remote storage 110) for access by a client device. After the scheduled time (e.g., a three hour window) has concluded, certificate management platform 104 can automatically revoke the certificate, and enforcement can be immediately propagated to the server providing the service so that any further connection to the server by the device will be rejected.

FIG. 3 illustrates a portion of a certificate configuration usable by certificate management platform 104. Configuration excerpt 300 illustrates configuration information for using smart remote persistence in GCP GSM. Similar configurations can be used for other remote storage infrastructure, such as AWS Secrets Manager, AWS S3, and Hashicorp Consul.

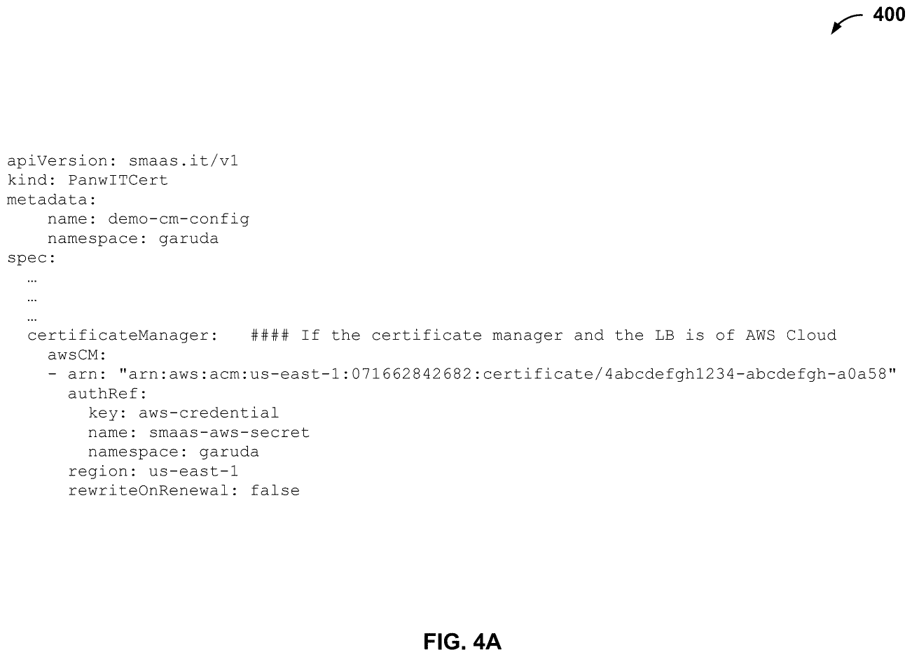

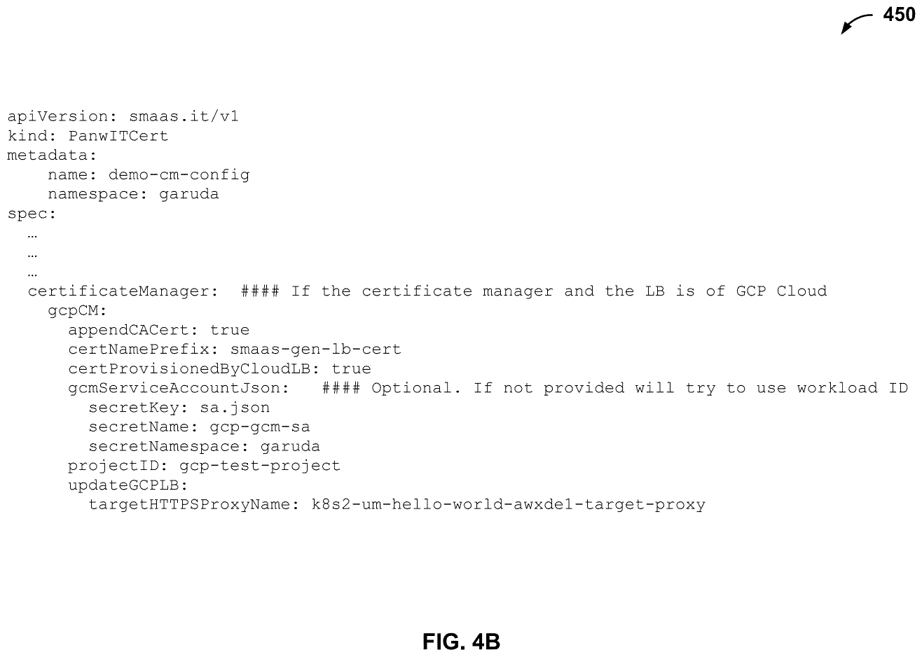

FIG. 4A illustrates a portion of a certificate configuration usable by certificate management platform 104. Configuration excerpt 400 illustrates configuration information for using smart persistence to a cloud certificate manager and to automatically update load balancers. In particular, configuration excerpt 400 illustrates configuration information using AWS infrastructure.

FIG. 4B illustrates a portion of a certificate configuration usable by certificate management platform 104. Configuration excerpt 450 illustrates configuration information for using smart persistence to a cloud certificate manager and to automatically update load balancers. In particular, configuration excerpt 450 illustrates configuration information using GCP infrastructure.

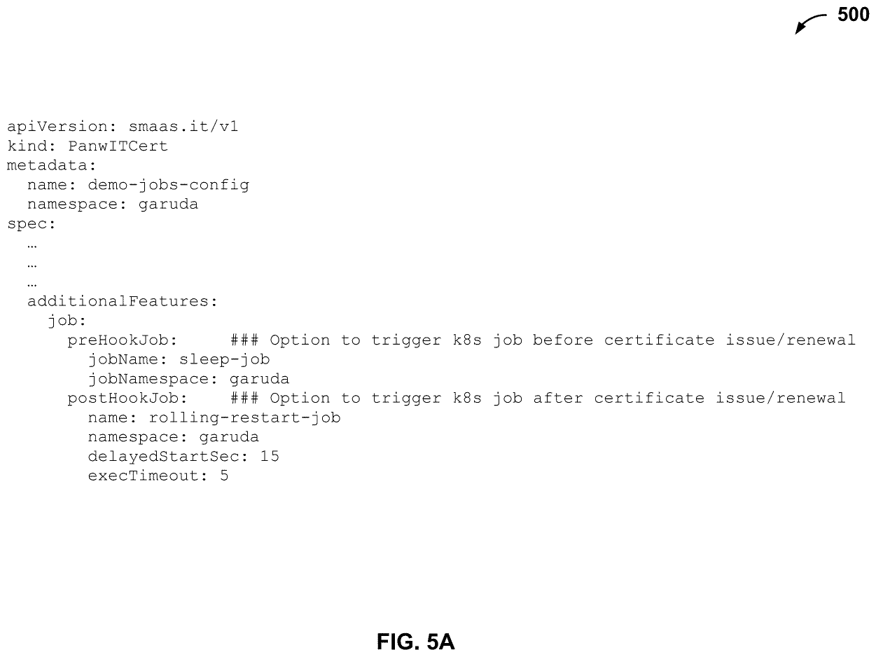

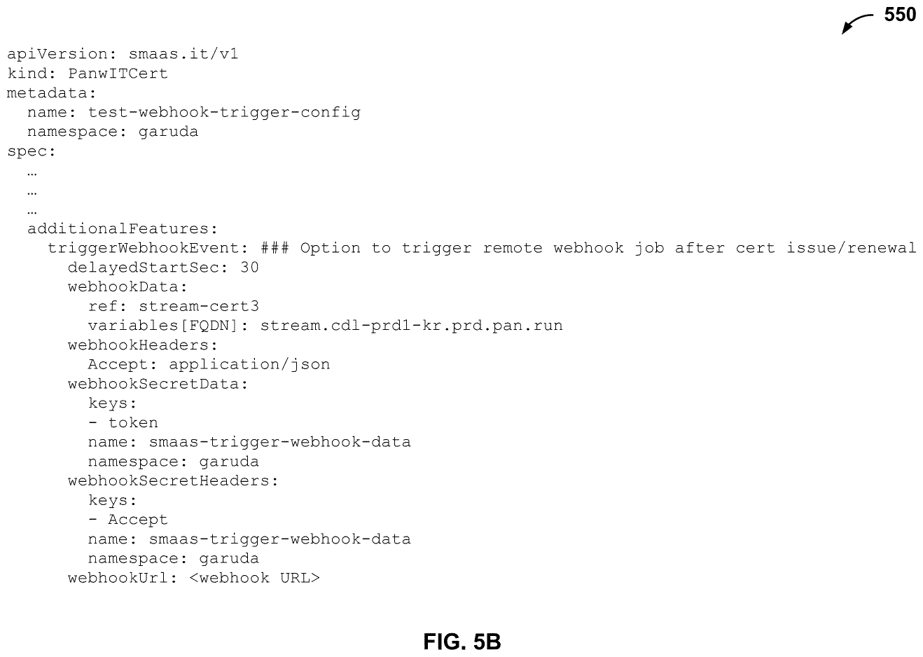

FIG. 5A illustrates a portion of a certificate configuration usable by certificate management platform 104. Configuration excerpt 500 illustrates configuration information for using pre and post hook executions to provide before and after certification issuance/renewal operations.

FIG. 5B illustrates a portion of a certificate configuration usable by certificate management platform 104. Configuration excerpt 550 illustrates configuration information for triggering webhook-based external jobs (e.g., argoCD, gitlab, Jenkins, etc.).

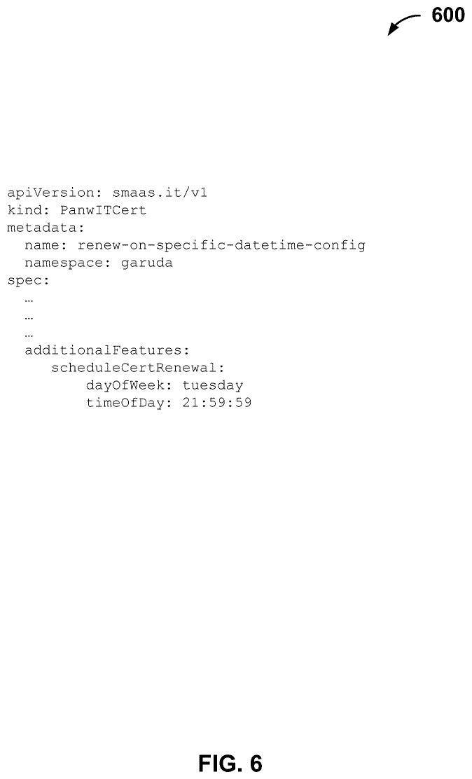

FIG. 6 illustrates a portion of a certificate configuration usable by certificate management platform 104. Configuration excerpt 600 illustrates configuration information for triggering a renewal at a particular date/time.

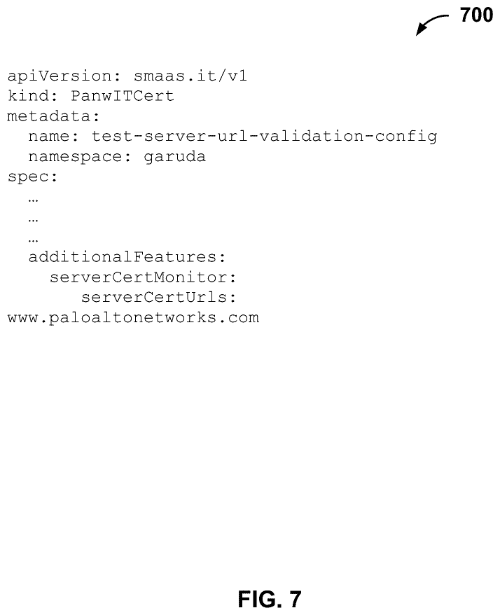

FIG. 7 illustrates a portion of a certificate configuration usable by certificate management platform 104. Configuration excerpt 700 illustrates configuration information for validating whether a server (e.g., server 114) is using a certificate managed by certificate management platform 104.

### IV. Example Workflows

As mentioned above, certificate management platform 104 provides for a unique comprehensive approach to the certificate management lifecycle that incorporates enhanced functionality with traditional stages of the certificate lifecycle. A particular configuration is defined for every particular certificate.

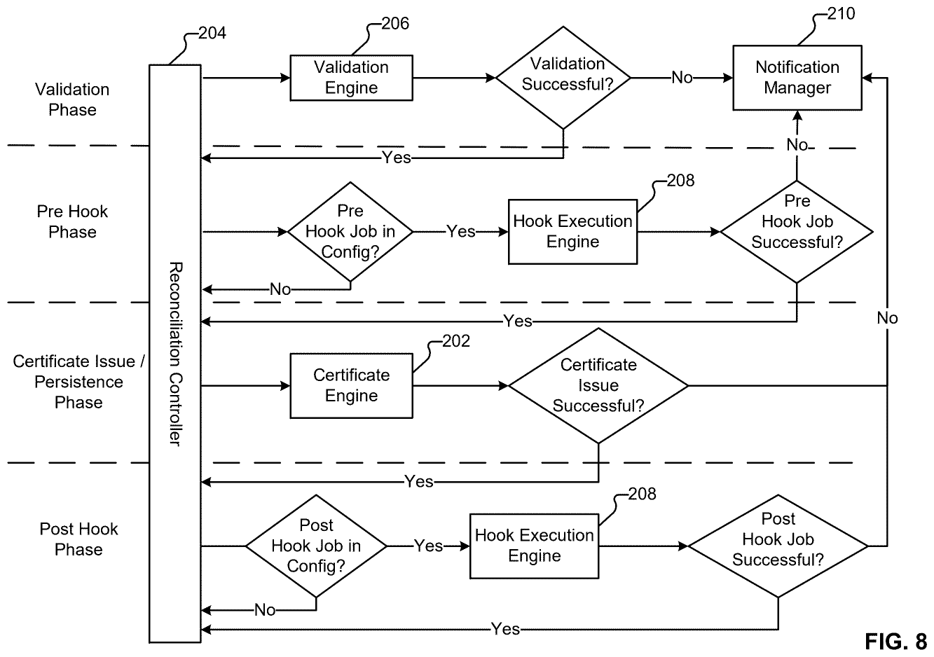

FIG. 8 illustrates various phases of certificate issuance and/or certificate update workflows. After configuration manager 212 accepts a configuration, as shown in FIG. 8, reconciliation controller 204 is involved in various phases of a certificate's lifecycle. During the validation phase, reconciliation controller 204 asks validation engine 206 to validate the certificate. If the validation is not successful, then notification manager 210 is triggered. Once the validation is complete, the pre-hook phase is entered. If there is a pre-hook job, hook execution engine 208 is asked to execute it. If the execution is not successful, then notification engine 210 is notified. The third phase is the certificate issuance/persistence phase, which triggers certificate engine 202. If the certificate issuance is not successful, notification manager 210 is triggered. Finally, in the post phase, if there is a post-hook job, hook execution engine 208 is asked to execute it. If the execution is not successful, then notification manager 210 is notified. As applicable, reconciliation (remediation) is performed.

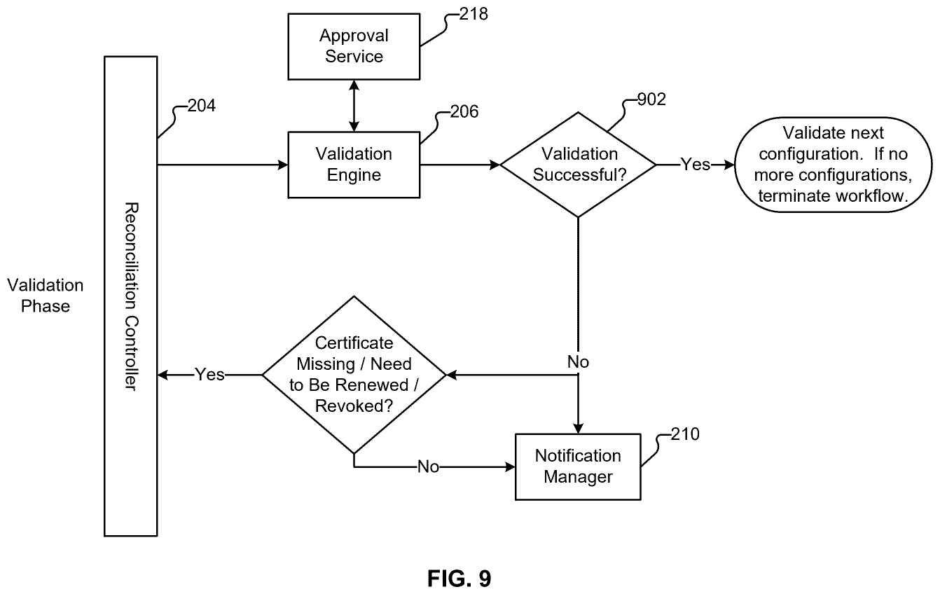

FIG. 9 illustrates an example of a periodic reconciliation workflow. In this example, validation engine 206 steps through each configuration, determining whether implicated certificates are validated or not. In some cases, validations need approval. As applicable, approval service 218 is engaged to determine approval status. Reasons that a validation might not be successful (at 902) include that a certificate is missing, should be renewed, is out of synchronization with the local copy stored at 108, etc. If a validation is unsuccessful, notification manager 210 is triggered. As applicable, reconciliation (remediation) is performed.

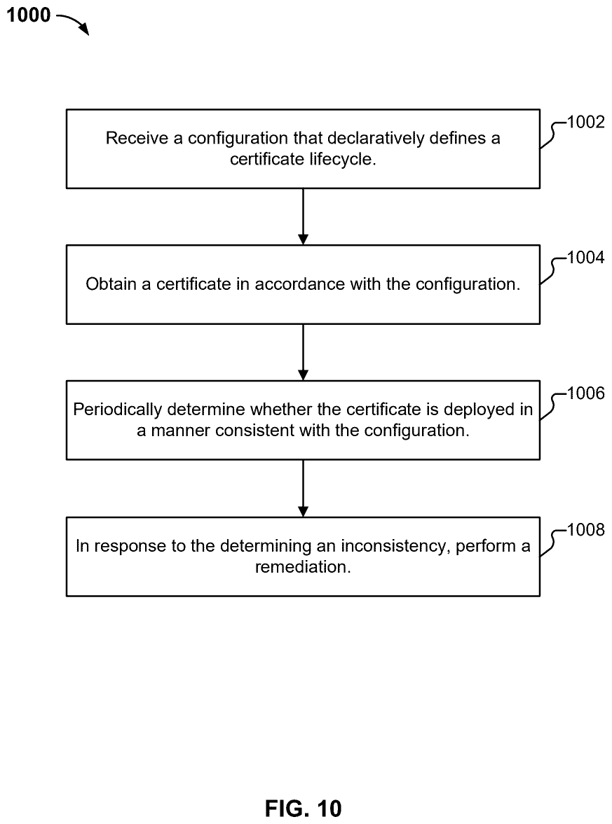

FIG. 10 illustrates an embodiment of a process for providing integrated certificate management. In various embodiments, Process 1000 is performed by certificate management platform 104. The process begins at 1002 when a configuration that declaratively defines a certificate lifecycle is received. Examples of portions of such configurations are illustrated in FIGS. 3-7 and generally described throughout. At 1004, a certificate is obtained in accordance with the configuration. In a first example, suppose the configuration is newly added to certificate management platform 104 and no corresponding certificate exists among local copies 108.

At 1004, certificate management platform 104 contacts certificate authority 120 (providing the applicable information as specified in the configuration) and stores the resulting certificate and keypair locally (108). In an example centralized implementation, certificates are managed in a single Kubernetes cluster (providing the functionality of certificate management platform 104) and managed certificates are stored in a remote persistence (e.g., remote storage 110). As mentioned above, as applicable, pre-and post-issuance tasks can be performed in connection with the processing performed at 1004. As an example, if the certificate needs to be requested/deployed within a particular time window, if any approvals are required, if the certificate material needs to be copied to a particular remote location or set of locations (e.g., both on remote storage 110 and on server 116), if an application (e.g., executing on server 114) needs to be restarted, those are addressed in connection with the processing at 1004 in various embodiments.

At 1006, a determination is made whether the certificate is deployed in a manner consistent with the configuration. Also as mentioned above, this determination is made periodically, for example, on a schedule specified within the configuration (e.g., check certificate A every 30 minutes; check certificate B every day), or, as applicable, a system-wide schedule (e.g., check all certificates four times a day). One example of an inconsistency that can be detected at 1006 is a mismatch between the locally stored (108) copy of the certificate and a remotely stored (e.g., at 110 or other location, such as server 116) copy. As mentioned above, this can happen for a variety of reasons, including an inadvertent change (e.g., a user mistakenly overwrites or deletes a copy of the certificate) or a malicious one. Another example of an inconsistency that can be detected at 1006 is where an endpoint (e.g., an application executing on server 116) is presenting/using the wrong version of a certificate. In an example of this scenario, certificate management platform 104 can periodically contact the application and compare the certificate (e.g., using serial numbers) presented by server 116 to the expected certificate (e.g., the local copy 108). Yet another example of an inconsistency that can be determined at 1006 is whether the certificate is due for renewal (e.g., is within a renewal window, is expired, or is revoked).

Finally, at 1008, in response to determining an inconsistency at 1006, a remediation is performed. One example of remediation includes copying the reference copy of the certificate information from certificate management platform 104 (108) to the appropriate location and running any applicable post-hooks. Another example of remediation (or aspect of remediation) includes obtaining approval from an appropriate party (e.g., to extend a just-in-time certificate). Another example of remediation is to determine that a certificate is on a certificate revocation list and to automatically obtain a new certificate (and as applicable, as subject to approval).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a configuration that declaratively defines a certificate lifecycle;
obtain a certificate in accordance with the configuration;
periodically determine whether the certificate is deployed in a manner consistent with the configuration; and
in response to the determining, perform a remediation; and
a memory coupled to the processor and configured to provide the processor with instructions.

2. The system of claim 1, wherein the certificate lifecycle is associated with an application.

3. The system of claim 1, wherein the obtained certificate is stored locally by a certificate management platform.

4. The system of claim 3, wherein a copy of the obtained certificate is also remotely stored at a remote storage.

5. The system of claim 4, wherein determining that the certificate is deployed in the manner consistent with the configuration includes verifying that the copy of the obtained certificate is synchronized with the certificate stored locally by the certificate management platform.

6. The system of claim 3, wherein a copy of the obtained certificate is also remotely stored at a load balancer.

7. The system of claim 1, wherein performing the remediation includes using a reconciliation controller.

8. The system of claim 1, wherein determining that the certificate is deployed in the manner consistent with the configuration includes confirming whether the certificate is on a certificate revocation list.

9. The system of claim 1, wherein determining that the certificate is deployed in the manner consistent with the configuration includes confirming, using a URL included in the configuration, that a server deploying the certificate is using a correct certificate.

10. The system of claim 1, wherein obtaining the certificate includes renewing the certificate.

11. The system of claim 10, wherein renewing the certificate includes performing a set of one or more pre-renewal actions.

12. The system of claim 10, wherein renewing the certificate includes performing a set of one or more post-renewal actions.

13. The system of claim 10, wherein renewing the certificate includes scheduling the renewal in accordance with the configuration.

14. The system of claim 1, wherein performing the remediation includes using a notification manager to send a notification using a channel specified in the configuration.

15. The system of claim 1, wherein the configuration is a first configuration and has a corresponding first certificate, and wherein the processor is further configured to receive a second configuration and obtain a second certificate in accordance with the second configuration, wherein the first and second configurations are different.

16. The system of claim 1, wherein the processor is configured to generate a runtime inventory of certificates and to which applications they are mapped.

17. The system of claim 1, wherein obtaining the certificate includes following an approval workflow that incorporates a manual or automatic approval phase.

18. The system of claim 1, wherein obtaining the certificate includes providing access on a timebound basis and automatically revoking the access if an extension is not approved.

19. A method, comprising:
receiving a configuration that declaratively defines a certificate lifecycle;
obtaining a certificate in accordance with the configuration;
periodically determining whether the certificate is deployed in a manner consistent with the configuration; and
in response to the determining, performing a remediation.

20. A computer program product embodied in a non-transitory computer readable medium and comprising computer instructions for:
receiving a configuration that declaratively defines a certificate lifecycle;
obtaining a certificate in accordance with the configuration;
periodically determining whether the certificate is deployed in a manner consistent with the configuration; and
in response to the determining, performing a remediation.
